(19) United States
(12) Patent Application Publication
(10) Pub. No.: US 2006/0213370 A1
(43) Pub. Date: Sep. 28, 2006

(54) MOBILE BIOGAS PROCESSING SYSTEM AND METHOD

(76) Inventors: Todd Leonard, Minnetonka, MN (US); Cecil Massie, Bloomington, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/276,746

(22) Filed: Mar. 13, 2006

Related U.S. Application Data
(60) Provisional application No. 60/660,890, filed on Mar. 11, 2005.

(51) Int. Cl. B01D 53/14

(52) U.S. Cl. 96/243

(57) ABSTRACT

This document discusses, among other things, a mobile biogas processing system that includes a mobile platform, a compressor physically coupled to the mobile platform, a pump physically coupled to the mobile platform and having a water input and a water output, and scrubber tower physically coupled to the mobile platform and having input connected to the compressor and water pump. In examples, the mobile platform is a skid or a combination of skids, a trailer, or a shipping container. An example method of using a mobile biogas processing system includes coupling a first biogas compressor, first scrubber, second scrubber, and flash tank to a mobile platform and delivering the platform and system components to a biogas site. In an example, the system includes its own water supply and burns biogas or crude methane to power pumps, compressors, and other components.

### RELATED APPLICATION

This application claims the benefit of priority, under 35 U.S.C. 119(e), to U.S. Provisional Application Ser. No. 60/660,890, filed on Mar. 11, 2005, which is incorporated herein by reference.

### TECHNICAL FIELD

This patent document pertains generally to biogas processing systems and methods, and more particularly, but not by way of limitation, to mobile biogas processing systems and methods.

### BACKGROUND

Biogas is produced, for example, by anaerobic fermentation of animal wastes or other waste products. Raw biogas is typically primarily a mixture of carbon dioxide and methane with trace levels of hydrogen sulfide and water vapor. Raw biogas is combustible, and has been used to generate electricity.

Biogas can also be processed to produce a cleaned or enriched product that can be used, for example, as a substitute for natural gas. The primary constituent of natural gas is methane, the same primary constituent as biogas. Biogas with enriched methane content can be used to power a vehicle, for example.

Many sources of biogas are located at remote locations, such as rural farms. Construction of permanent biogas processing systems at farms can prohibitively expensive or inefficient. Transport of methane-producing waste products to processing facilities can also be impractical and inefficient due to transport and storage concerns. Improved biogas processing systems and methods are needed.

### SUMMARY

An example mobile biogas processing system includes a mobile platform; a first compressor physically coupled to the mobile platform and having a biogas input and a compressed biogas output, a first pump physically coupled to the mobile platform and having a water input and a water output, and a first scrubber tower physically coupled to the mobile platform. The first scrubber tower includes a mixing chamber, a compressed gas input, a water input coupleable to the water output of the first pump, a water output, and a processed gas output. The mixing chamber is in communication with the compressed gas input, the compressed gas output, the water input and the water output. In an example, the mobile biogas processing system also includes a second scrubber tower physically coupled to the mobile platform, the second scrubber tower having a mixing chamber, a compressed gas input in communication with the output of the first scrubber tower, a water input, a water output, and a processed gas output. In an example, the mobile biogas processing system also includes a flash tank physically coupled to the mobile platform, the flash tank having a water input coupled to the water output of the first scrubber, a water output, and a gas recirculation output.

In an example, the mobile biogas processing system also includes a means for removing water and/or hydrogen sulphide from biogas before the biogas enters the first compressor.

In an example, the mobile platform includes one or more skids, a plurality of skids, a truck bed, a trailer, and/or a container.

In an example, the mobile biogas processing system also includes at least one engine operable on methane or biogas, and a hydraulic system coupled to the gas-powered engine

Another example mobile biogas processing system includes a compression system, a scrubbing system, a flash system. The compression system has an input in communication with a biogas source, a compressed biogas output. The scrubbing system has a biogas input in communication with the compressed biogas output of the compression system, a water input, a processed gas output, and a water output. The flash system has a water input in communication with the water output of the scrubbing system, a water output, and a gas output in communication with a gas recirculation line coupled to the compression system. At least the scrubbing system is physically coupled to the mobile platform. In an example, the system also includes a biogas storage system that is physically coupled to the mobile platform. In an example, the scrubbing system includes a plurality of scrubber towers physically coupled to the mobile platform

An example method includes coupling a first biogas compressor to a mobile platform, and coupling a first scrubber tower to the mobile platform. The mobile platform, biogas compressor, and first scrubber tower are deliverable to a location having a biogas source. In an example, the method further includes coupling an output of the biogas compressor to a biogas input on the first scrubber tower, and/or coupling a flash tank to the mobile platform and coupling a scrubber tower water outlet to the flash tank. In an example, the method also includes supplying a biogas to the compressor, delivering compressed biogas from the compressor to the scrubber tower, delivering water to the scrubber tower, and exposing the compressed biogas to the water in the scrubber tower, and outputting a processed gas from the scrubber tower.

In an example, the method further includes supplying air to the scrubber tower and bleeding biogas or methane from the scrubber tower to prepare the scrubber tower for transport.

In an example, the method further includes remotely monitoring the processing of biogas, and sending a command from a remote location to adjust at least one processing parameter and electrically executing the command. In an example, the method includes operating the mobile biogas processing system of claim so as to produce a processed gas that includes about 90% to about 100% methane.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic illustration of an example of a mobile biogas processing system.

FIG. 2 is a schematic illustration of an example of a mobile biogas processing system that includes a compressor, first and second biogas scrubbers, and a flash tank.

FIG. 3 is a schematic illustration of an example of a biogas compression system that includes a fan, a moisture knockout vessel, and a compressor.

FIG. 4 is a schematic illustration of an example biogas scrubbing system that includes first and second scrubber towers and a flash tank.

FIG. 5 is a schematic illustration of an example water supply system.

FIG. 6 is a schematic illustration of an example analysis and final processing system and a gas transport vehicle.

FIG. 7A is a schematic illustration of an example scrubber tower.

FIG. 7B is an illustration of an example of a scrubber tower.

FIG. 8 is a schematic illustration of an example multi-skid mobile biogas processing system.

FIG. 9A is an illustration of an example mobile biogas processing system on a trailer.

FIG. 9B is an illustration of an example scrubber tower rotatably mounted on a trailer.

FIG. 10 is an illustration of an example container including an example mobile biogas processing system.

FIG. 11 is a flow chart that illustrates an example method of using a mobile biogas processing system.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference.

An example mobile biogas processing system includes a mobile platform and biogas processing components mounted on the platform. The mobile platform includes one or more skids, a trailer, a truck, and/or a container, for example. The mobile platform is transportable to a remote site such as a farm where biogas is available for processing. In some examples, the components of the processing system are designed for road and/or rail transport and are sized to process farm-scale quantities of biogas. In an example, the biogas processing system includes sensing and communication systems that allow for remote monitoring and remote control of the processing system, which can be advantageous because staffing is not necessarily available at all times at remote processing locations. In some examples, the system requires little or no on-site assembly.

Biogas processing has been conducted at large fixed processing plants. Processing plants typically remove carbon dioxide from biogas through water absorption, polyethylene glycol absorption, carbon molecular sieves, or membrane separation. Hydrogen sulphide is removed by air/oxygen dosing to digester biogas, iron chloride dosing to digester slurry, or other processes. In some instances, siloxane, halogenated hydrocarbons, oxygen or nitrogen are also removed from biogas. The present mobile systems and methods include some or all of the capability of plant-based systems, and make this capability available at remote biogas sites, such as farms. Biogas sites include farms, landfills, wastewater treatment plants, and other locations where organic material is generated or gathered. Biogas is generated from a variety of sources, such as waste from cattle, hogs, chickens, turkeys and other animals, as well as human waste and plant products.

Water absorption or “water scrubbing” techniques are predicated on the relative solubility of methane and carbon dioxide in water. Carbon dioxide is more soluble in water under pressure than at atmospheric pressure. Methane is mostly insoluble even at elevated pressures. Pressurizing a methane/carbon dioxide biogas mixture in the presence of water drives carbon dioxide into solution in the water but drives little methane into solution. The resulting processed biogas has an enriched methane content because some or all of the carbon dioxide has been processed out of the gas and into solution in the water. The optimum relative solubility difference for methane and carbon dioxide is in the range from 150 to 200 pounds per square inch gauge (psig). In some systems, the carbon dioxide-laden water generated in the water scrubbing process is passed to a flash vessel operated at a lower pressure than the water absorption system. A portion of the methane absorbed in the water during the scrubbing process can be recaptured in the flash vessel, because methane desorbs from water more easily than carbon dioxide.

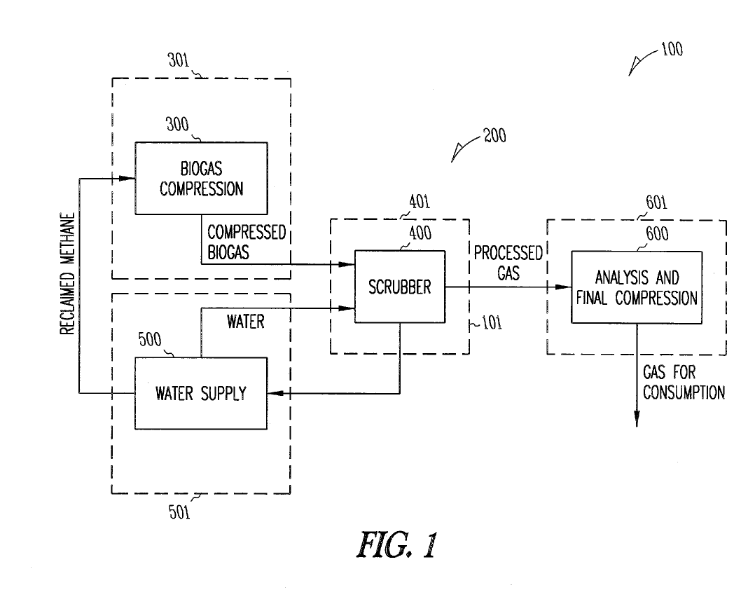

FIG. 1 is a schematic illustration of an example of a mobile biogas processing system 100 that includes a mobile platform 101 and processing system 200 that includes a biogas compression system 300, biogas scrubber system 400, water supply system 500, and analysis and final processing system 600. Water and biogas are processed through components of the biogas compression system 300, biogas scrubber system 400, water supply system 500, and analysis and final processing system 600 to process biogas into a more usable form, such as methane.

Raw biogas is supplied to a biogas compression system 300. In some embodiments of the invention, the raw biogas is produced at a biogas site utilizing anaerobic digestion of organic materials, e.g., manure, e.g., human, hog, turkey, chicken and/or cattle manure. The organic materials may be located at a biogas site, e.g., a landfill or a farm. Raw biogas typically includes a mixture of carbon dioxide and methane with trace levels of hydrogen sulfide and water vapor.

In an example, the compression system 300 first removes at least some of the hydrogen sulfide and water vapor and then compresses the biogas. In one example, the moisture content is reduced to less than about 1.4%, and the biogas is compressed to an operating pressure of about 150 to about 200 psig. The compressed operating pressure is a function of the temperature, carbon dioxide mole fraction in the gas, and the desired methane purity

The compressed biogas is supplied to the biogas scrubber system 400. The scrubber system 400 is also connected to a water supply system 500 that pumps water into the scrubber system. The gas flows in counter-flow or cross-flow with the water. As the gas flows past the water, carbon dioxide is absorbed into the water. Some methane is typically also absorbed into the water. However, substantially less methane is absorbed into the water than carbon dioxide because of the difference in relative water solubility between methane and carbon dioxide. In an example, at about 200 psig, nearly all of the carbon dioxide in biogas is absorbed into water and about 5% of methane is absorbed, even though methane is the more prevalent component in biogas.

In one example, the scrubber system 400 includes two or more sequential scrubber towers that move biogas and water in counter-flow. In an example, the scrubber system includes one or more vertical columns that contain Rashig rings, sieve plates, bubble cap or disk and donut gas/liquid contact devices. In another example, the scrubber system 400 includes one or more cross-flow chambers in which water is passed in cross-flow over the biogas.

In an example, water output from the scrubber returns to the water supply system 500. In an example, methane is reclaimed from the water output of the scrubber system 400. In an example, the reclaimed methane is recirculated into the biogas compression system 300.

The scrubber system 400 outputs a processed gas. In an example, the processed or “cleaned” gas is crude methane. The processed gas is delivered to an analysis and final processing system 600. In an example, the analysis and final processing system 600 samples the processed gas to determine its makeup. The processed gas is burnable for energy. In an example, water vapor and trace contaminants are removed from the processed gas. In an example, the analysis and final processing system also further compresses the gas to prepare it for transport via truck, pipeline or other transport as compressed natural gas (CNG) or liquefied natural gas (LNG). In an example, the gas is fully processed by the mobile biogas processing system 100. In another example, the processed gas is post-processed on site or off site.

In some embodiments of the invention, the processed gas contains from about 90% to about 100% (e.g., at least about 95%; at least about 98%; about 90%; about 91%; about 92%; about 93%; about 94%; about 95%; about 96%; about 97%; about 98%; about 99%; or about 100%) methane gas.

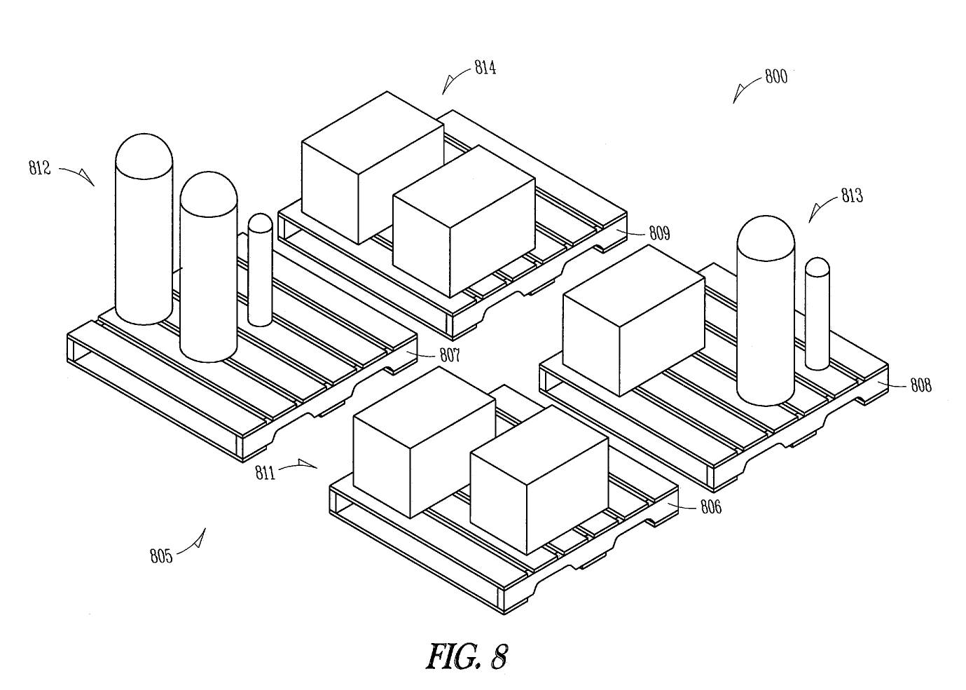

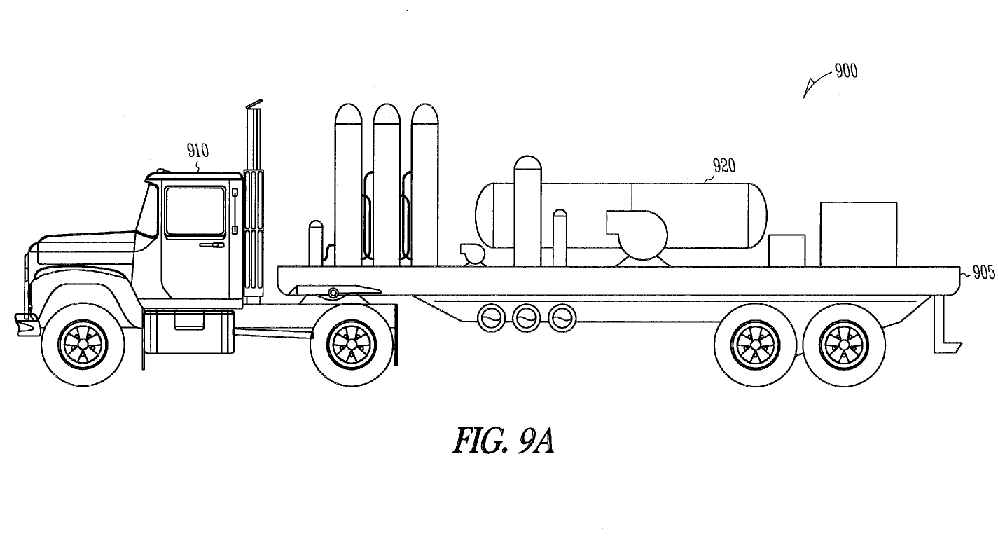

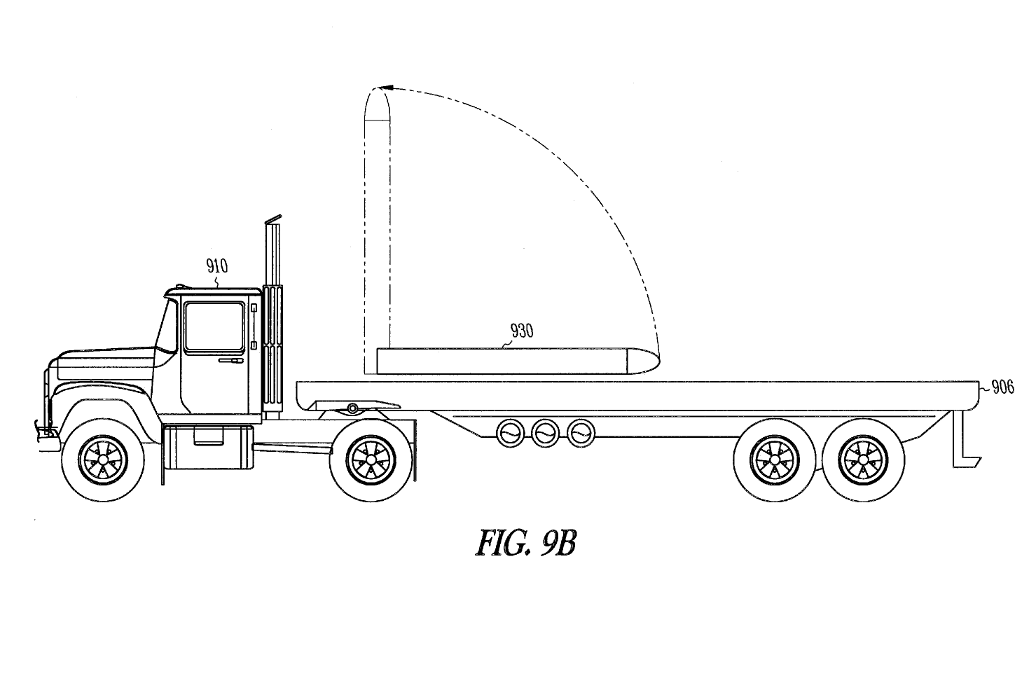

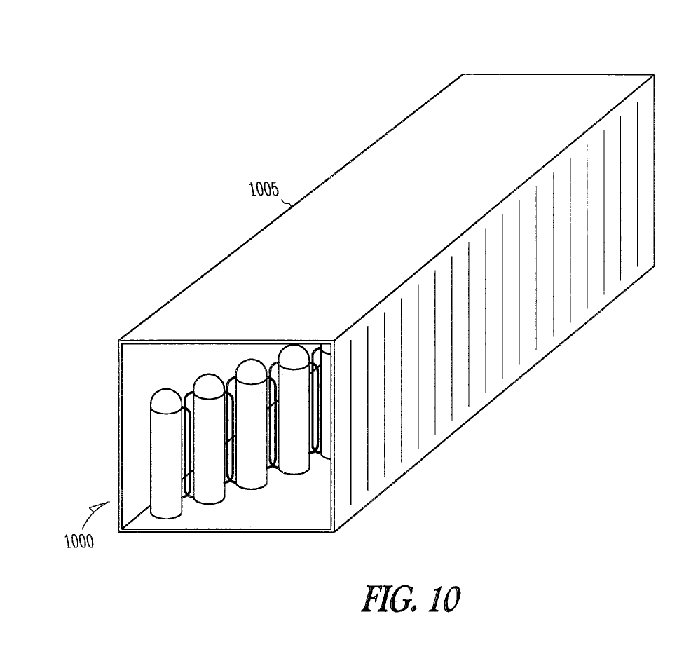

In an example, the systems 300, 400, 500, 600 are mounted on a single unitary platform, such as a truck bed or a shipping container. FIGS. 9A and 9B show example configurations with a system installed on a truck trailer. FIG. 10 shows an example configuration in which a system is installed in a shipping container. In another example, the processing system is broken into four separate mobile units 301, 401, 501, 601. In an example, each mobile unit 301, 401, 501, 601 includes a skid or other platform component and biogas processing components. FIG. 8 shows an example in which a system is mounted on four skids. In an example, the mobile units are modular, so that one unit can be removed and replaced with a different unit, which is interfaced with the other units at a biogas processing site.

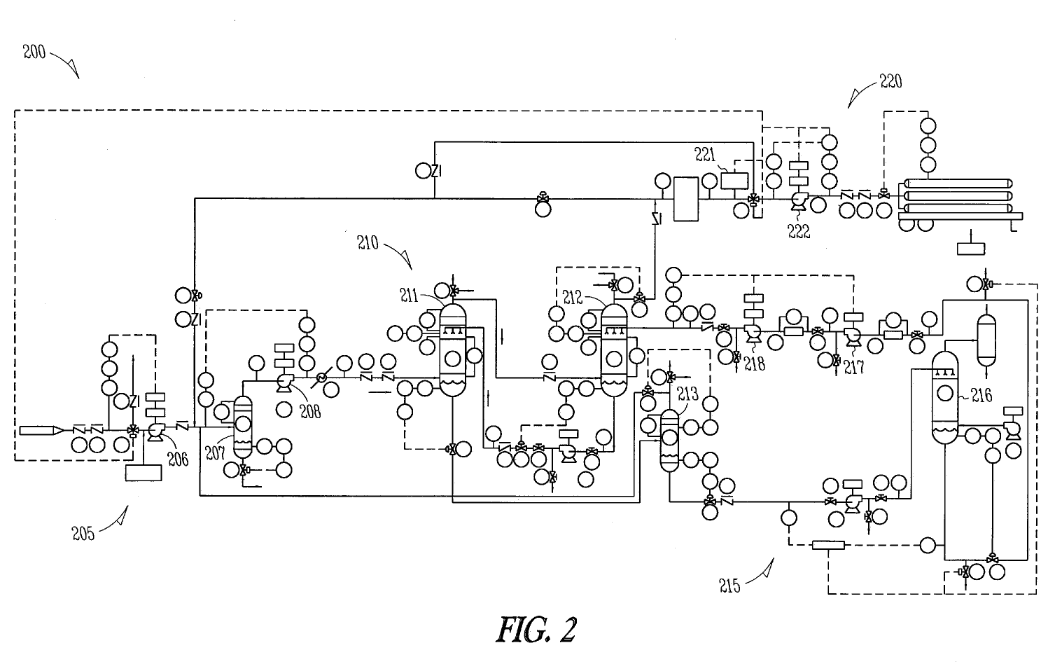

FIG. 2 is a schematic illustration of numerous example components of the biogas processing system 200. The example system 200 includes a compression system 205, a biogas scrubbing system 210, a water supply system 215, and an analysis and final processing system 220. In an example, the compression system 205 includes a fan 206, a moisture knockout vessel 207, and a compressor 208 that provides compressed biogas to the biogas scrubbing system. In an example, the biogas scrubbing system 201 includes serially-arranged first and second scrubber towers 211, 212 and a flash tank for reclaiming dissolved methane from water output from the scrubber towers. In alternative examples, more scrubber towers are used. For example, the example containerized system shown in FIG. 10 includes multiple scrubber towers. The example water supply system includes a series of pumps 217, 218 that provide water to the scrubber towers 211, 212, and a CO₂ stripper 216 that removes CO₂ from the scrubber output water. The analysis and final processing system 220 receives processed gas (e.g. crude methane) from the scrubber system 210 includes a drier and purifier 221, an analysis module 222, and a compressor 223. It is understood that there are other possible combinations of components in the subsystems 205, 210, 215, 220. For example the flash tank could be considered part of the water supply system.

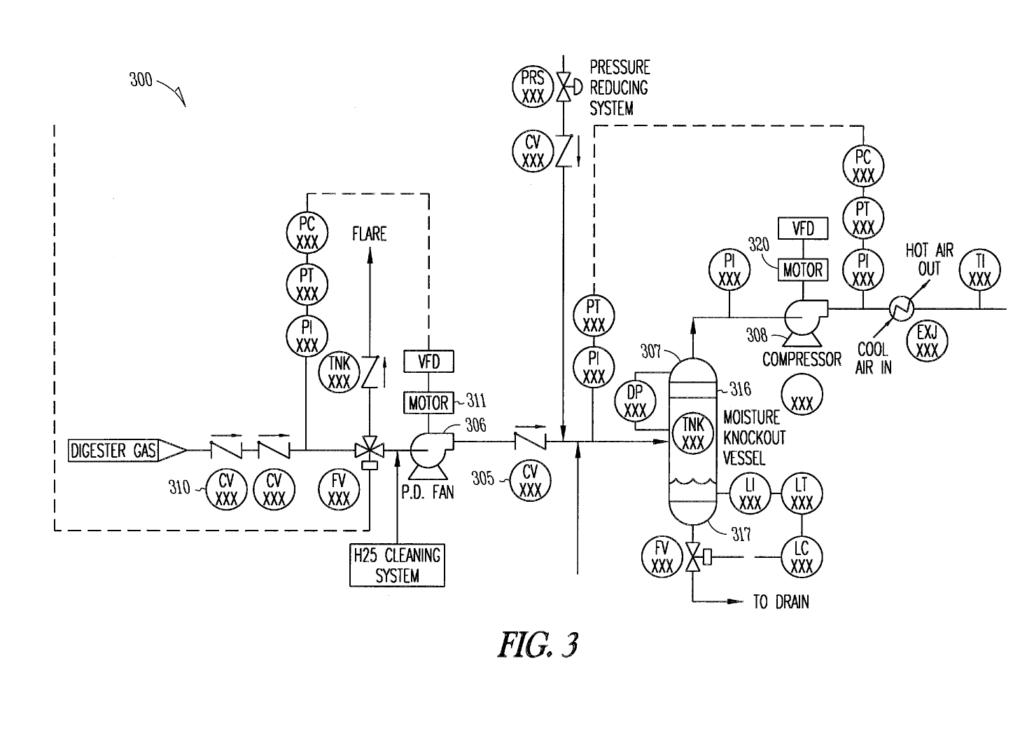

FIG. 3 is a schematic illustration of an example of the biogas compression system 300. The example system 300 includes a fan 306, a moisture knockout vessel 307, and a compressor 308. Raw biogas is fed from a digester through one or more valves 310 into the system 300. A hydrogen sulfide cleaning system removes hydrogen sulfide from the biogas. The biogas passes through the fan 306, which is powered by a motor 311. The gas passes through another valve 315 and into the optional moisture knockout vessel 307. The moisture knockout vessel 307 includes a mist pad 316 and a drain 317. Gas output from the moisture knockout vessel 307 enters the compressor 308, which is powered by a motor 320. In an example, one or both of the motors 311, 320 is a hydraulic motor driven by a hydraulic pump that is powered by a biogas-operable engine or a crude methane-operable engine. Using biogas or methane energy to power the motors allows the system to be self-contained. In one example, the system includes a tank of fuel such as propane that starts the system, and the system converts over to crude methane produced by the biogas processing system 400 after the system is started.

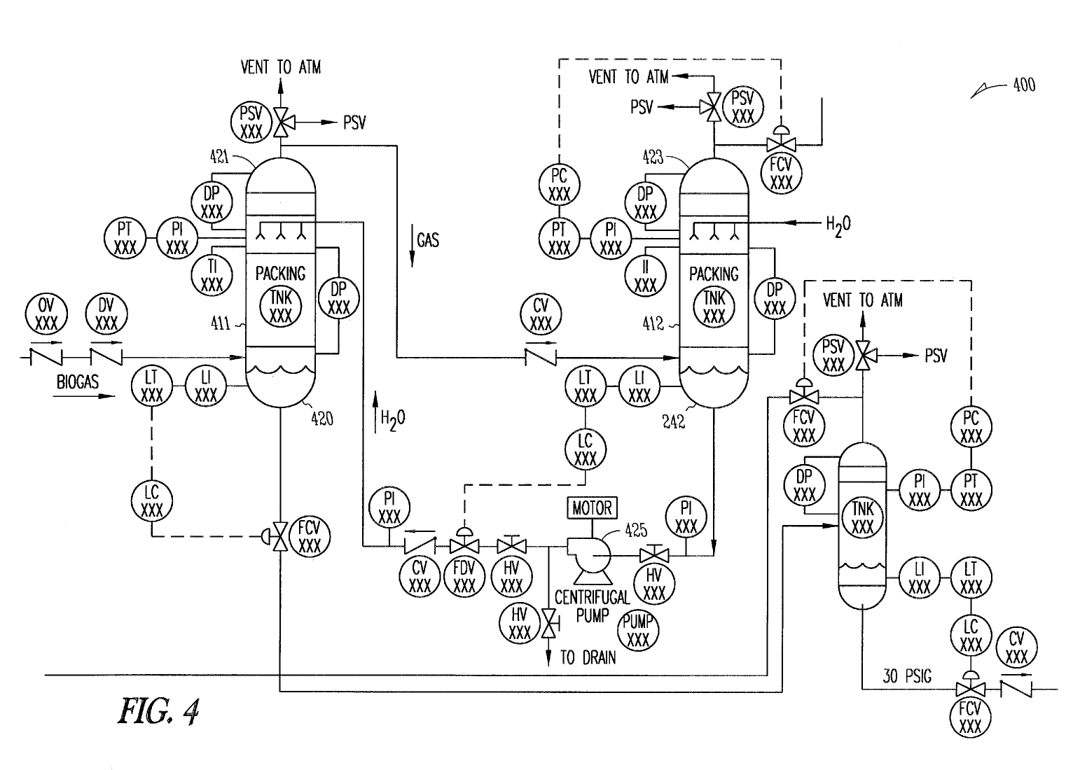

FIG. 4 is a schematic illustration of an example biogas scrubbing system 400 that includes first and second scrubber towers 411, 412 and a flash tank 413. Compressed biogas is introduced at the bottom 420 of tower 411. Water is introduced near the top 421 of the tower 411. In an example, the water is recirculating water, water recovered from the discharge of an anaerobic digester, or fresh water. In an example, recovered water is filtered or otherwise processed to removes solids that can plug the tower.

As water moves down the tower, biogas flows up the tower and exits near the top 421 of the tower 411. At least some of the carbon dioxide in the gas absorbs into the water. The gas exiting the top of the tower has a higher concentration of methane than the gas entering the bottom of the tower because some of the carbon dioxide is removed from the gas.

In the example shown in FIG. 4, two sequential scrubber towers are used. The gas exiting the top 421 of the first tower 411 is introduced into the bottom of the second tower 412. Water enters at the top 423 of the second tower 412 and gas is introduced at the bottom 424 of the second tower 412. In the example shown in FIG. 4, gas flows in counter-current to the water: Water exiting the bottom of the second tower enters a pump 425 and is delivered to the top of the first tower. In another example, water is provided directly to each cylinder instead of circulating through the cylinders. Supplying the water in counter-current to the gas makes more efficient use of water. Directly supplying fresh or de-gassed water provides more efficient or effective biogas scrubbing in some situations, for example when the water would become saturated with carbon dioxide in counter-current flow through the towers.

Water output from the scrubbers is directed to an optional flash tank 413. The flash tank 413 subjects the water to a pressure decrease, which pulls at least some of the methane out of the water. In an example the water output from the scrubbers is at about 150 to about 200 psig, and the flash tank is at about 25-50 psig. Because of the difference in solubility between methane and carbon dioxide, methane desorbs out of the water more quickly than carbon dioxide. In the example shown in FIG. 4, reclaimed methane that is flashed out of the water is introduced back into the compression system.

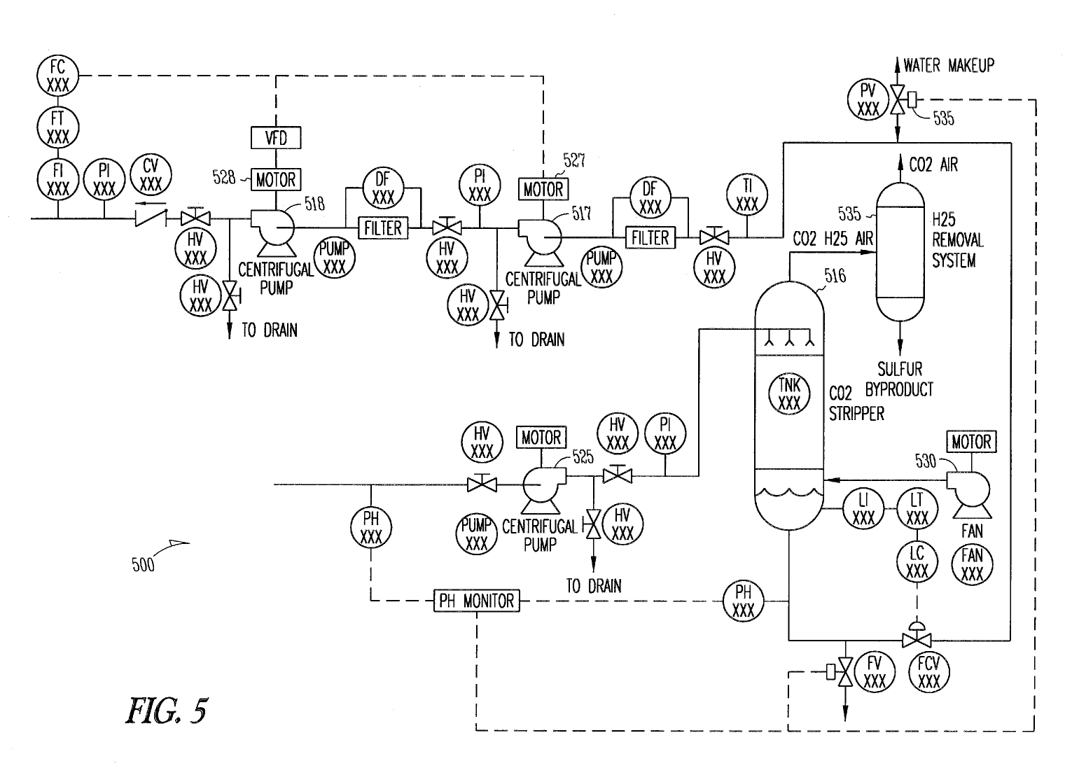

FIG. 5 is a schematic illustration of an example water supply system 500. The water supply system 500 includes water pumps 517, 518 driven by respective motors 527, 528. The pumps 517, 518 supply water to biogas scrubbers. In an example, the motors 527, 528 are driven hydraulically by a hydraulic pump that is powered by a biogas or methane engine. In an example, the first pump outputs water at about 30 psig and the second pump outputs water at about 150-200 psig. Water coming out of the scrubbers is processed by an optional flash tank (shown in FIG. 4) and then delivered to pump 525, which delivers water to the top of a CO₂ stripper 516. In an example, a sump is coupled to an inlet of the pump 525, and water output from the flash tank is delivered to the sump. The air/CO₂/H₂S mixture is delivered out of the stripper 516 to a hydrogen sulfide removal system 535 that outputs a sulfur byproduct.

Water output from the CO₂ stripper 516 has reduced CO₂/H₂S or no CO₂/H₂S. In an example, a pH monitor 540 detects the pH of water before and after passing through the CO₂ stripper 516. The water output from the CO₂ stripper 516 is supplied to the pumps 517, 518, which recirculate the water through the stripper system. In an example, a water makeup valve 535 is provided to replace water that is lost through evaporation in the CO₂ stripper or elsewhere in the system. In an example, the water makeup valve 535 is coupled to a water tank or other reservoir that is part of the mobile biogas processing system. This allows the water supply system to be self contained and operable with no external supply of water. A self-contained system is advantageous, because it enables the gas processing system to operate regardless of the on-site water situation. In another example, makeup water is provided externally, but the majority of the scrubbing system water requirement is met by recirculated water. In other examples, external water supplies or containment areas are used. For example, desorbtion can be handled by a pond or reservoir. In other examples, desorbtion is accomplished using a cooling tower or an open vertical pipe.

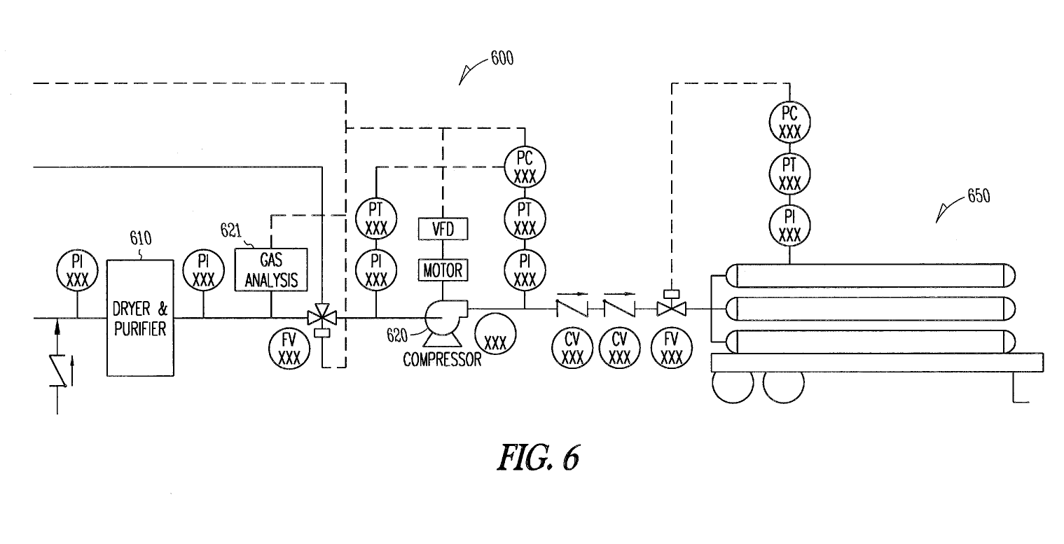

FIG. 6 is a schematic illustration of an example analysis and final processing system 600 and a gas transport vehicle. In an example, the analysis and final processing system 600 removes water vapor and trace contaminants from the processed gas, tests the composition of the gas, and compresses the gas for storage or transport via truck or pipeline. Processed biogas such as crude methane that is output from the scrubber system is passed through a drier and purifier 610 that removes water vapor and trace contaminants. Air driers and purifiers are commercially available, for example, from Pioneer Air Systems. Driers and/or purifiers and related components are described in U.S. Pat. Nos. 4,761,968, 4,638,852, 4,499,033, 5,107,919 and 5,207,895.

In an example, a valve draws off a portion of the dried and purified gas to be burned by a combustion engine that powers some or all of the various motors in the biogas processing system through hydraulic or mechanical connections.

Returning to FIG. 6, the dried and purified gas is delivered to a compressor 620. In an example, the compressor is driven by a 150 horsepower hydraulic motor that is coupled to a biogas or methane-operable combustion engine. In an example, the compressor 620 compresses the processed gas to up to about 3600 psig to produce compressed natural gas (CNG). In an example, the processed gas is further processed into liquid natural gas (LNG). In an example, the mobile biogas processing system delivers CNG or LNG to a tanker trailer 650. In another example, the mobile biogas processing system delivers CNG or LNG to a pipeline connection. In another example, the mobile biogas processing system includes a storage system, such as a tank on a trailer.

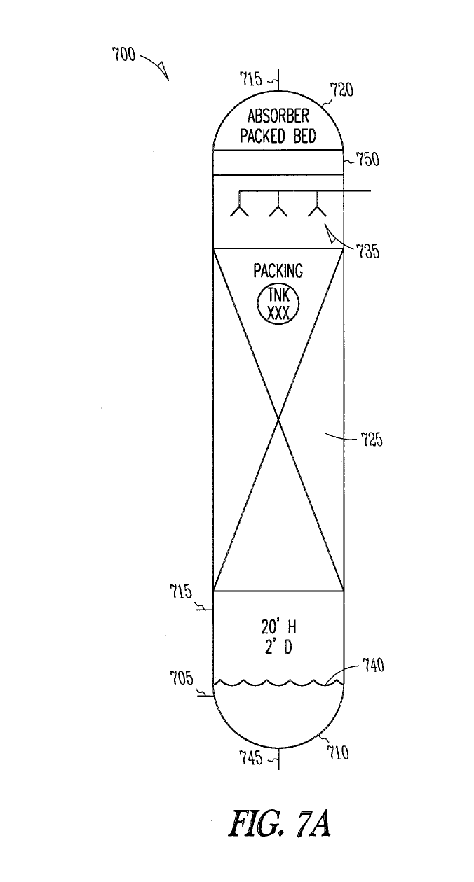

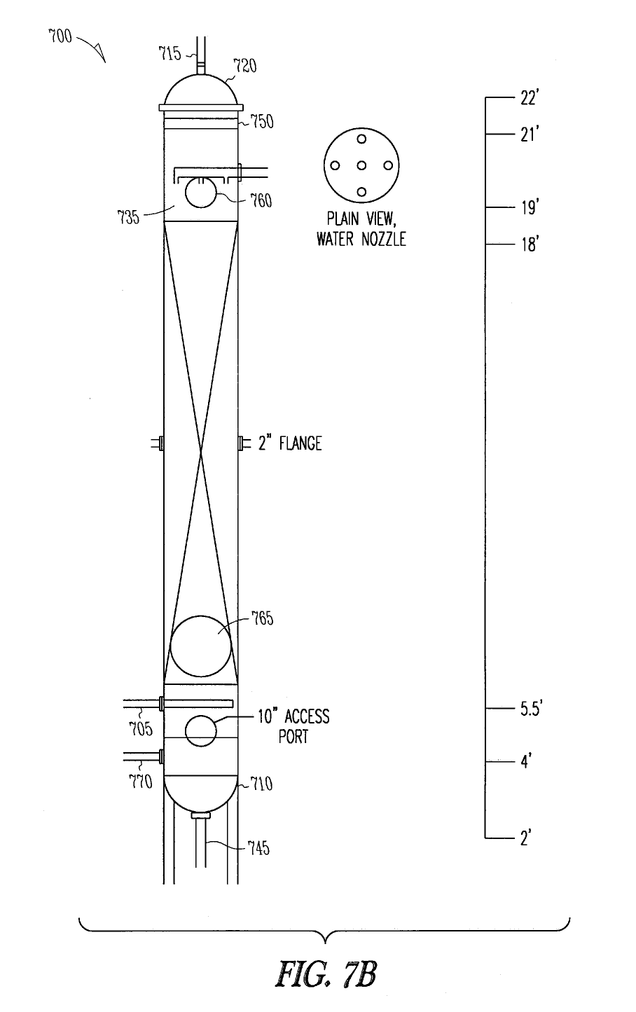

FIG. 7A is a schematic illustration of an example scrubber tower 700. The tower includes a gas input 705 at the bottom 710 of the tower, a gas output 715 at the top 720 of the tower, and packing 725 in a middle portion of the tower 730. Sprayers 735 near the top 720 of the tower 700 spray water into the tower in counter-flow with gas circulating up from the bottom of the tower. Water collects in a pool 740 at the bottom of the tower and flows out a water output 745 in the bottom of the tower. The pool of water 740 prevents the gas from exiting through the water output.

The tower 700 includes a demist pad 750 near the top 720 of the tower. The demist pad 750 removes water from the upwardly-flowing gas stream.

FIG. 7B is an illustration of an example of a scrubber tower having a top 720 and bottom 710, gas input 705 and gas output 715, water input sprayers 735 and water output 745, and demist pad 750, as well as an access port 760, manway 765, and water level control outlet 770. In an example, the tower is 20 feet tall and two feet in diameter, with 12½ feet of packing.

FIG. 8 is an illustration of an example mobile biogas processing system 800 in which a mobile platform 805 includes a number of skids 810. A compression system 811 is mounted to a first skid 806. A biogas scrubbing system 812 is mounted to a second skid 807. A water supply and processing system 813 is mounted to a third skid 808. A final processing and compression system 814 is mounted to a fourth skid 809. The systems 811, 812, 813, 814 are connectable together to process biogas. The components of the systems are shown schematically and are merely representative of components described in detail elsewhere in this application.

The systems 811, 812, 813, 814 are separable for transport. In an example, the systems 811, 812, 813, 814 are modular, so that one of the systems can be replaced or upgraded and integrated with the other systems to process biogas. For example, scrubbing capacity can be upgraded by replacing the scrubbing system 812 with a larger system.

FIG. 9A is an illustration of an example mobile biogas processing system 900 on a trailer 905. In an example, the necessary components of the biogas processing system 900 are all mounted or integrated onto the trailer. In another example, some of the components are carried on a skid or located locally at biogas sites. In an example, a trailer can be dropped off at a site by a truck 910 and retrieved later. In an example, the trailer also includes a processed gas storage tank 920, so that the biogas can be transported by use of the trailer.

FIG. 9B is an illustration of another example of a biogas scrubber tower 930 on a trailer 935. The scrubber tower is rotatable from a reclined position for transit to an upright position for biogas processing. In an example, multiple towers are provided on the trailer 935. In an example, the tower 930 is 20 feet tall and two feet in diameter.

FIG. 10 is an illustration of an example mobile biogas processing system 1000 mounted in a container 1005. In an example, the container is a standard shipping container that is transportable by truck, rail, or ship. In another example, the container is sized and shaped to fit within a standard shipping container. In an example, the biogas processing components are securable in the container to prevent access by unauthorized persons. In an example, gas or fluid connections are provided in the container walls.

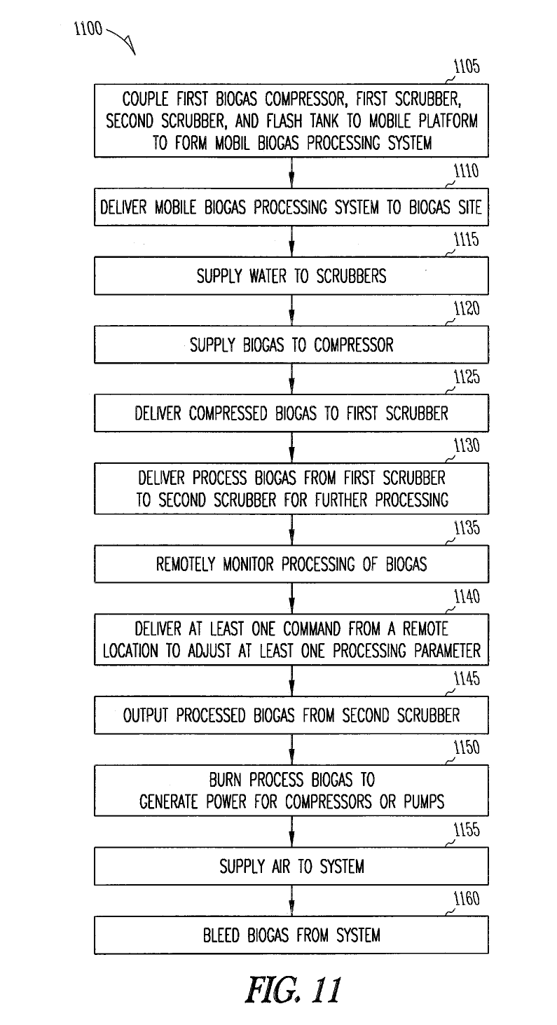

FIG. 11 is a flow chart that illustrates an example method 1100 of using a mobile biogas processing system. At 1105, a first biogas compressor, first scrubber, second scrubber, and flash tank are coupled to a mobile platform to form mobile biogas processing system. At 1110, the mobile biogas processing system is delivered to a biogas site. At 1115, water is supplied to scrubbers. In an example, water is supplied from a water tank that is coupled to the mobile platform. In another example, some or all of the water is supplied from an external source. At 1120, biogas is supplied to the first biogas compressor. In an example, biogas is drawn from a digester by a fan, processed to reduce the water content of the biogas, and then delivered to the first biogas compressor. At 1125, compressed biogas is delivered to the first scrubber. The biogas flows past water in the scrubber in counter-flow or cross-flow. Carbon dioxide absorbs into the water from the biogas. After the biogas leaves the first scrubber, it enters the second scrubber for further cleaning.

In an example, the processing of biogas is monitored remotely, at step 1135. A computer coupled to sensors and a communications link detects processes characteristics such as methane quality, flow rates, pressures, and/or temperatures, and relays such information through the communication link. Remote monitoring allows a system to be run without personnel on site. At 1140, a command can be issued from a remote location to adjust at least one processing parameter. In an example a processing parameter is adjusted through the computer. In another example, a person is directed to the site to tend to the system.

At 1145, processed biogas is output from the second scrubber. The processed gas exiting the second scrubber has a lower carbon dioxide content and higher methane concentration than the raw biogas. In an example, crude methane is output from the second scrubber.

At 1150, biogas is burned to generate power for compressors or pumps in the biogas processing system. In another example, processed gas or methane is burned to generate power.

The system is prepared for transit by supplying air to the system at 1155 and bleeding biogas from the system at 1160.

Gas processing techniques are described in U.S. Pat. Nos. 3,981,800 and 4,409,102 and in Perry's Chemical Engineer Handbook, pp. 14-28 to 14-30 (4^{th} Ed. 1963).

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A mobile biogas processing system comprising:
a mobile platform;
a first compressor physically coupled to the mobile platform, the compressor having a biogas input and a compressed biogas output;
a first pump physically coupled to the mobile platform and having a water input and a water output; and
a first scrubber tower physically coupled to the mobile platform, the first scrubber tower having a mixing chamber, a compressed gas input, a water input coupleable to the water output of the first pump, a water output, and a processed gas output, the mixing chamber in communication with the compressed gas input, the compressed gas output, the water input and the water output.

2. The mobile biogas processing system of claim 1, further comprising a second scrubber tower physically coupled to the mobile platform, the second scrubber tower having a mixing chamber, a compressed gas input in communication with the output of the first scrubber tower, a water input, a water output, and a processed gas output.

3. The mobile biogas processing system of claim 2, further comprising a second pump physically coupled to the mobile platform, the second pump having an output coupled to the water input of the second scrubber tower.

4. The mobile biogas processing system of claim 3, wherein the second pump has an input coupled to an external water reservoir.

5. The mobile biogas processing system of claim 1, further comprising a flash tank physically coupled to the mobile platform, the flash tank having a water input coupled to the water output of the first scrubber, a water output, and a gas recirculation output, wherein at least one biogas component extracted from water output from the first scrubber is recirculateable at least through the first pump and first scrubber tower.

6. The mobile biogas processing system of claim 1, further comprising a means for removing water from biogas having a gas input, a water output, and a gas output coupleable to the input of the first compressor, the means for removing water from biogas configured to reduce the water content of the biogas before the biogas enters the first compressor.

7. The mobile biogas processing system of claim 6, wherein the means for reducing water content is also configured to remove hydrogen sulphide from biogas.

8. The mobile biogas processing system of claim 1, wherein the mobile platform is a skid.

9. The mobile biogas processing system of claim 1, wherein the mobile platform includes a plurality of skids.

10. The mobile biogas processing system of claim 9, wherein the mobile platform includes a first skid, the compressor physically coupled to the first skid.

11. The mobile biogas processing system of claim 10, wherein the mobile platform includes a second skid, the first scrubber tower physically coupled to the second skid.

12. The mobile biogas processing system of claim 11, wherein the mobile platform includes a third skid, the pump physically coupled to the third skid.

13. The mobile biogas processing system of claim 12, wherein the mobile platform includes a fourth skid, a compression system physically coupled to the fourth skid, the compression system having a processed gas input and a compress processed gas output.

14. The mobile biogas processing system of claim 1, wherein the mobile platform includes a truck bed.

15. The mobile biogas processing system of claim 1, wherein the mobile platform includes a trailer.

16. The mobile biogas processing system of claim 1, wherein the mobile platform includes a container.

17. The mobile biogas processing system of claim 1, further comprising at least one gas-powered engine providing a power output.

18. The mobile biogas processing system of claim 17, wherein the compressor and water pump are coupled to the power output of the engine.

19. The mobile biogas processing system of claim 18, further comprising a hydraulic system coupled to the gas-powered engine, the compressor and water pump driven by the hydraulic system.

20. The mobile biogas processing system of claim 17, wherein the gas-powered engine is a biogas-operable engine.

21. The mobile biogas processing system of claim 17, wherein the gas-powered engine is a methane-operable engine.

22. The mobile biogas processing system of claim 17, wherein the engine is operable to provide power to an external system through the electrical output.

23. A mobile biogas processing system comprising:
a compression system having an input in communication with a biogas source and a compressed biogas output;
a scrubbing system having a biogas input in communication with the compressed biogas output of the compression system, a water input, a processed gas output, and a water output;
a flash system having an water input in communication with the water output of the scrubbing system, a water output, and a gas output in communication with a gas recirculation line coupled to the compression system; and
a mobile platform, the scrubbing system physically coupled to the mobile platform.

24. The mobile biogas processing system of claim 23, wherein the compression system and flash system are physically coupled to the mobile platform.

25. The mobile biogas processing system of claim 24, further comprising a biogas storage system having an input in communication with the processed gas output of the scrubbing system, the biogas storage system is physically coupled to the mobile platform.

26. The mobile biogas processing system of claim 23, further comprising a second mobile platform, at least one of the compression system and the flash system physically coupled to the second mobile platform.

27. The mobile biogas processing system of claim 23, wherein the scrubbing system includes a plurality of scrubber towers physically coupled to the mobile platform

28. The mobile biogas processing system of claim 23, wherein the scrubbing system includes first and second scrubbing towers, a processed gas output of the first scrubbing tower in communication with a biogas input of the second scrubbing tower, and a water output of the second scrubbing tower in communication with a water input of the first scrubbing tower.

29. A method comprising:
coupling a first biogas compressor to a mobile platform; and
coupling a first scrubber tower to the mobile platform,
wherein the mobile platform, biogas compressor, and first scrubber tower are deliverable to a location having a biogas source.

30. The method of claim 29, further comprising coupling an output of the biogas compressor to a biogas input on the first scrubber tower.

31. The method of claim 29, further comprising coupling a flash tank to the mobile platform and coupling a scrubber tower water outlet to the flash tank.

32. The method of claim 29, further comprising supplying a biogas to the compressor, delivering compressed biogas from the compressor to the scrubber tower, delivering water to the scrubber tower, and exposing the compressed biogas to the water in the scrubber tower, and outputting a processed gas from the scrubber tower.

33. The method of claim 32, further comprising:
coupling a second biogas tower to the mobile platform;
delivering water to the second biogas tower
delivering the processed gas from the first scrubber tower to the second scrubber tower;
exposing the processed gas from the first scrubber tower to the water in the second biogas tower; and
outputting a further processed gas from the second scrubber tower.

34. The method of claim 32, further comprising delivering the processed gas to a biogas transport system.

35. The method of claim 32, further comprising burning the processed gas to produce power.

36. The method of claim 35, further comprising driving the compressor with power produced from burning the processed gas.

37. The method of claim 36, wherein driving the compressor includes delivering power through a hydraulic system.

38. The method of claim 32, wherein outputting a processed gas from the scrubber tower includes outputting crude methane.

39. The method of claim 32, further comprising remotely monitoring the processing of biogas.

40. The method of claim 39, wherein remotely monitoring the processing of biogas includes detecting at least one processing characteristic with at least one sensor and transmitting data related to the at least one processing parameter to a remote location.

41. The method of claim 40, further comprising sending a command from a remote location to adjust at least one processing parameter and electrically executing the command.

42. The method of claim 32, wherein the processed gas comprises from about 90% to about 100% methane.

43. The method of claim 42, wherein the processed gas comprises at least about 95% methane.

44. The method of claim 33, wherein the processed gas comprises from about 90% to about 100% methane.

45. The method of claim 44, wherein the processed gas comprises at least about 95% methane.

46. The method of claim 45, wherein the processed gas comprises at least about 98% methane.

47. The method of claim 32, wherein supplying biogas to the compressor includes supplying biogas obtained from waste or wastewater from cattle, hogs, turkeys, or chickens.

48. The method of claim 32, wherein supplying biogas to the compressor includes supplying biogas obtained from human waste or human wastewater.

49. The method of claim 32, wherein supplying biogas to the compressor includes supplying biogas obtained from a landfill.

50. A method for producing a processed gas, comprising operating the mobile biogas processing system of claim 1 so as to produce a processed gas.

51. The method of claim 50, wherein the processed gas comprises from about 90% to about 100% methane.

52. The method of claim 51, wherein the processed gas comprises at least about 95% methane.

53. The method of claim 52, wherein the processed gas comprises at least about 98% methane.

54. A method for producing a processed gas, comprising operating the mobile biogas processing system of claim 23 so as to produce a processed gas.

55. The method of claim 54, wherein the processed gas comprises from about 90% to about 100% methane.

56. The method of claim 55, wherein the processed gas comprises at least about 95% methane.

57. The method of claim 56, wherein the processed gas comprises at least about 98% methane.
